(19) United States
(12) Patent Application Publication
(10) Pub. No.: US 2023/0289976 A1
(43) Pub. Date: Sep. 14, 2023

(54) Multi-component system for computerized x-ray vision to track motion during surgery

(71) Applicant: Claire SooHoo, Los Angeles, CA (US)

(72) Inventor: Claire SooHoo, Los Angeles, CA (US)

(21) Appl. No.: 17/690,238

(22) Filed: Mar. 9, 2022

(51) Int. Cl. G06T 7/20; G06T 7/80

(52) U.S. Cl. CPC G06T 7/20; G06T 7/80; G06T 2207/10088; G06T 2207/10081; G06T 2207/30008

(57) ABSTRACT

The present invention relates to a device track motion through a computerized image of bones or other structures derived from a single x-ray or other image of said structure, comprising: sensors that, when moved, would send measurements of its movement to this image or images, allowing the image or images to move according to the sensor's movement. This would minimize the radiation exposure while still allowing surgeons to see an accurate depiction of patients' internal structures and their placements. This device could develop a three-dimensional or two-dimensional reconstruction of the bone/s or other structure/s based on the x-rays provided. This image could move along the X, Y, or Z axes.

### STATEMENT REGARDING FEDERALLY SPONSORED RESEARCH OR DEVELOPMENT

This invention was made without government support.

### BACKGROUND OF THE INVENTION

In orthopedic surgery, common types of procedures include fixation of bone and soft tissues as well as reconstruction of degenerated or damaged bone and soft-tissues. Alignment of these bone and soft tissues is commonly used to fix or reconstruct bone and soft tissue in the proper position. Currently, the alignment of bone is tracked by intra-operative imaging including x-ray fluoroscopy.

The current methods of tracking the motion of bone with intra-operative fluoroscopy has several disadvantages. One disadvantage is that intra-operative fluoroscopy exposes the patient and operative team to radiation. In orthopaedic surgery, x-ray technology is used to provide both still and moving images of the internal structures of patients. X-rays pose a range of risks to anyone exposed to them. These include but are not limited to cataracts, reddened skin, hair loss, infertility, and cancer. Much of what is known of x-rays' health risks is a result of studying survivors of the atomic bomb's nuclear radiation, and there may be other side effects still unknown to us. Patients are at lower risk because they are only exposed for one period of time (the operation). However, surgeons are exposed to x-rays many times over the course of their careers. Lead coats are worn by the surgeon, but these still leave parts of their bodies exposed. The risk of radiation exposure limits the frequency that images can be taken with the result being that tracking of motion is intermittent. A new x-ray is taken every time a bone is repositioned, exposing patients and surgeons to more radiation. This method is also time-consuming. This can result in the position of bone changing between images without the surgeon being aware. Fluoroscopy, which also uses x-ray technology, can be used to provide moving images of internal structures. Fluoroscopy can result in a multitude of the aforementioned health issues associated with x-rays, and also emits more radiation than machines used to produce still x-rays.

Thus, there is a need in the art for improved tracking of motion of bone that provides continuous visualization without the need for continuous exposure to radiation. The present invention meets this need.

### SUMMARY OF THE INVENTION

The present invention relates to a device track motion through a computerized image of bones or other structures derived from a single x-ray or other image of said structure, comprising: sensors that, when moved, would send measurements of its movement to this image or images, allowing the image or images to move according to the sensor's movement. This would minimize the radiation exposure while still allowing surgeons to see an accurate depiction of patients' internal structures and their placements. This device could develop a three-dimensional or two-dimensional reconstruction of the bone/s or other structure/s based on the x-rays provided. This image could move along the X, Y, or Z axes.

In one embodiment, the sensor used would connect to a microcontroller that would in turn be connected to a computer, which would display the image.

In one embodiment, multiple sensors would be used to track to the motion of more than one bone fragment.

In one embodiment, the computer images would be displayed in orthogonal planes

In one embodiment, the motion in each orthogonal plane would be track and visualized separately using the absolute position sensor data

In one embodiment, the borders of the object tracked would be manually selected by the user.

In one embodiment, computer algorithms would be used to automatically identify the borders of the object tracked.

In one embodiment the sensors would be placed directly on a bone fragment to be tracked.

In one embodiment, the sensors would be placed on a pin or to other appliance attached to the bone fragment to be tracked.

In one embodiment, computer algorithms would be used to correct for the position of the sensor relative to the bone in order to more accurately track motion of a bone fragment.

In one embodiment, tracking of bone or soft tissue structures would be visualized using computerized tomography images.

In one embodiment, tracking of bone or soft tissue structures would be visualized using magnetic resonance imaging images.

### BRIEF DESCRIPTION OF THE DRAWINGS

The following detailed description of exemplary embodiments of the invention will be better understood when read in conjunction with the appended drawings. It should be understood, however, that the invention is not limited to the precise arrangements and instrumentalities of the embodiments shown in the drawings.

FIG. 1 depicts multiple exemplary position sensor used to track and display motion of bone fragments to provide computerized x-ray vision.

FIG. 2 is a flowchart of an exemplary method of using position sensors to track motion of bone fragments without the need for repeated radiation exposure.

### DETAILED DESCRIPTION

The present invention relates to devices for tracking and visualizing motion of bones and their associated soft-tissue structures including joints, muscles, tendons, ligaments, and nervous tissues. The devices use sensors that attach to bone and soft tissue to track motion. The sensors relay information to a computer image for visualization of motion.

### Definitions

It is to be understood that the figures and descriptions of the present invention have been simplified to illustrate elements that are relevant for a clear understanding of the present invention, while eliminating, for the purpose of clarity, many other elements typically found in the art. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined elsewhere, all technical and scientific terms used herein have the same meaning as commonly understood by one of ordinary skill in the art to which this invention belongs. Although any methods and materials similar or equivalent to those described herein can be used in the practice or testing of the present invention, exemplary methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, and ±0.1% from the specified value, as such variations are appropriate.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6, and any whole and partial increments there between. This applies regardless of the breadth of the range.

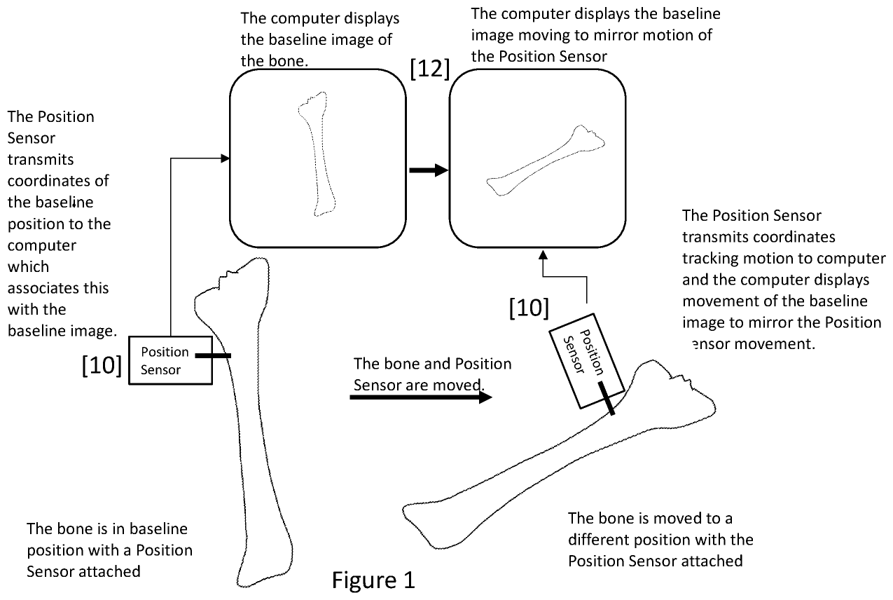

Referring now to FIG. 1, an exemplary sensor 10 and connected computer 12 where x-ray or other visualizations of bone or soft tissue are depicted. Sensor 10 comprises an absolute position sensor with 9 degrees of freedom. The sensor is mounted to bone or soft tissue. When sensor 10 is moved, the computer 12 displays movement of the image or images used to visualize bone or soft tissue. In various embodiments, baseline visualization is obtained from x-rays, computed tomography, or magnetic resonance imaging.

In some embodiments, the sensor 10 reports data to the computer 12 for visualization through a wired connection.

In some embodiments, the sensor 10 reports data to the computer 12 for visualization through a wireless connection.

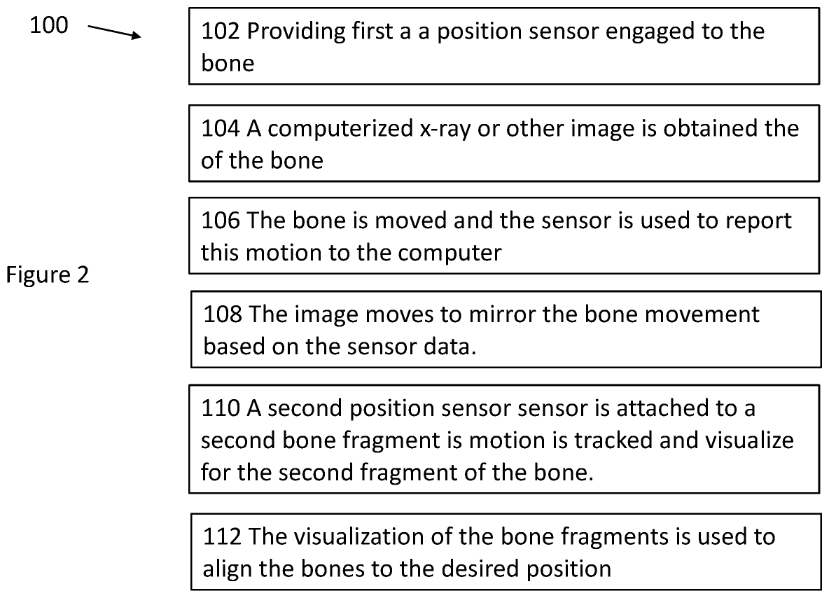

As described elsewhere herein, the present invention provides a device for tracking and visualization of motion of bones and their associated soft-tissue structures. Referring now to FIG. 2, an exemplary method 100 of tracking an visualizing motion is depicted. Method 100 begins with step 102, wherein a position sensor is engaged to the bone. In step 104, a computerized x-ray or other image is obtained the of the bone. In step 106, the bone is moved and sensor used to report this motion to the computer. In step 108, the image moves to mirror the bone movement based on the sensor data. In step 110, a sensor is attached to a second bone fragment is motion is tracked and visualize for the second fragment of the bone. In step 112, the visualization of the bone fragments is used to align the bones to the desired position.

It should be understood that the method is not limited to the use of one sensor. Any number of sensors may be provided to align as many fragments of a bone as needed. It should also be understood that the method may be adapted for other tissues, such as muscle, skin, and organs, or adapted to track any object in a space.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed is:

1. A device to track motion through a computerized image of bones or other structures derived from a single image of said structure, comprising:
a computerized image of bones or other structures derived from a single x-ray or other image of said structure
a sensor that, when moved, would send measurements of its movement to this image or images, allowing the image to move according to the sensor's movement.

2. The device of claim 1, the sensor used would connect to a microcontroller that would in turn be connected to a computer, which would display the image.

3. The device of claim 1, wherein multiple sensors would be used to track to the motion of more than one bone fragment.

4. The device of claim 1, wherein the computer images would be displayed in orthogonal or additional planes.

5. The device of claim 1, wherein the motion in each orthogonal plane or additional plane would be track and visualized separately using the absolute position sensor data.

6. The device of claim 1, wherein the borders of the object tracked would be manually selected by the user.

7. The device of claim 1, wherein computer algorithms would be used to automatically identify the borders of the object tracked.

8. The device of claim 1, wherein the sensors would be placed directly on a bone fragment to be tracked.

9. The device of claim 1, wherein the sensors would be placed on a pin or to other appliance attached to the bone fragment to be tracked.

10. The device of claim 9, wherein computer algorithms would be used to correct for the position of the sensor relative to the bone in order to more accurately track motion of a bone fragment.

11. The device of claim 1, wherein tracking of bone or soft tissue structures would be visualized using computerized tomography images.

12. The device of claim 1, tracking of bone or soft tissue structures would be visualized using magnetic resonance imaging images.
